(19) United States
(12) Patent Application Publication
(10) Pub. No.: US 2026/0130492 A1
(43) Pub. Date: May 14, 2026

(54) Bible Cover Purse

(71) Applicant: Ama Ampofo, Oshawa (CA)

(72) Inventor: Ama Ampofo, Oshawa (CA)

(21) Appl. No.: 19/364,811

(22) Filed: Oct. 21, 2025

Related U.S. Application Data
(60) Provisional application No. 63/718,983, filed on Nov. 11, 2024.

(51) Int. Cl. A45F 5/12; B42D 3/04; B42D 3/08

(52) U.S. Cl. CPC A45F 5/12; B42D 3/045; B42D 3/08

(57) ABSTRACT

The bible cover purse functions and looks like a purse that may hold a book such as a bible. The bible cover purse provides users with a device that protects a bible or book while providing a unique design along the front and rear. The bible cover purse has a book housing which encompasses the bible or book. Further it has handles that provides the user with an easy place to hold the bible cover purse. The bible cover purse secures a front and rear portion of a book with the front page pocket and the rear page pocket positioned along the inside of the book housing.

### FIELD OF THE INVENTION

The present invention relates generally to a book cover for a Bible that looks like a purse. More specifically, the present invention is a device that properly protects a Bible or book.

### BACKGROUND OF THE INVENTION

Book covers are the protective outer layers that encase the pages of a book, serving both practical and aesthetic purposes. They protect the book from wear, tear, dirt, and other environmental factors, helping to preserve its longevity. Book covers come in various forms, including hardcovers, paperbacks, and dust jackets, each designed for different levels of durability and presentation.

Beyond protection, book covers play a critical role in conveying the theme, genre, and tone of the book, often being the first aspect that catches a reader's eye. Additionally, many book covers provide readers with a way to place their own design or aesthetic along the cover of a book. However, many of these book covers provide proper protection, but do not aid in additional storage or improving transportation of the book being protected.

An objective of the present invention is to provide users a Bible cover purse, that properly protects a Bible and enables easy transportation of the book. The present invention intends to provide users with a device that can encase a book and provide a purse appearance. In order to accomplish that, a preferred embodiment of the present invention comprises a book housing 1 and a plurality of handles 2. Further, the book housing 1 provides proper protection for the book within the present invention. Thus, the present invention is a bible cover purse that properly encompasses a book and provides a purse design.

### BRIEF DESCRIPTION OF THE DRAWINGS

FIG. 1 is a top front left perspective view of the present invention in a closed configuration.

FIG. 2 is a bottom rear right perspective view of the present invention.

FIG. 3 is a front view of the present invention.

FIG. 4 is a rear view of the present invention.

FIG. 5 is a right-side view of the present invention.

FIG. 6 is a left-side view of the present invention.

FIG. 7 is a top view of the present invention.

FIG. 8 is a bottom view of the present invention.

FIG. 9 is an example of the front design or rear design.

FIG. 10 is an example of the front design or rear design.

FIG. 11 is an example of the front design or rear design.

FIG. 12 is a top front left perspective view of the present invention in an open configuration.

FIG. 13 is a top rear left perspective view of the present invention in an open configuration.

### DETAILED DESCRIPTION OF THE INVENTION

All illustrations of the drawings are for the purpose of describing selected versions of the present invention and are not intended to limit the scope of the present invention.

The present invention is a bible cover that looks like a purse. The present invention seeks to provide users with a device that protects a bible or book while providing a unique design along the front and rear. In order to accomplish this the present invention comprises a book housing 1 which encompasses the bible or book. Further, the plurality of handles 2 provides the user with an easy place to hold the present invention. Thus, the present invention is a bible cover purse that properly encompasses a book and provides a purse design.

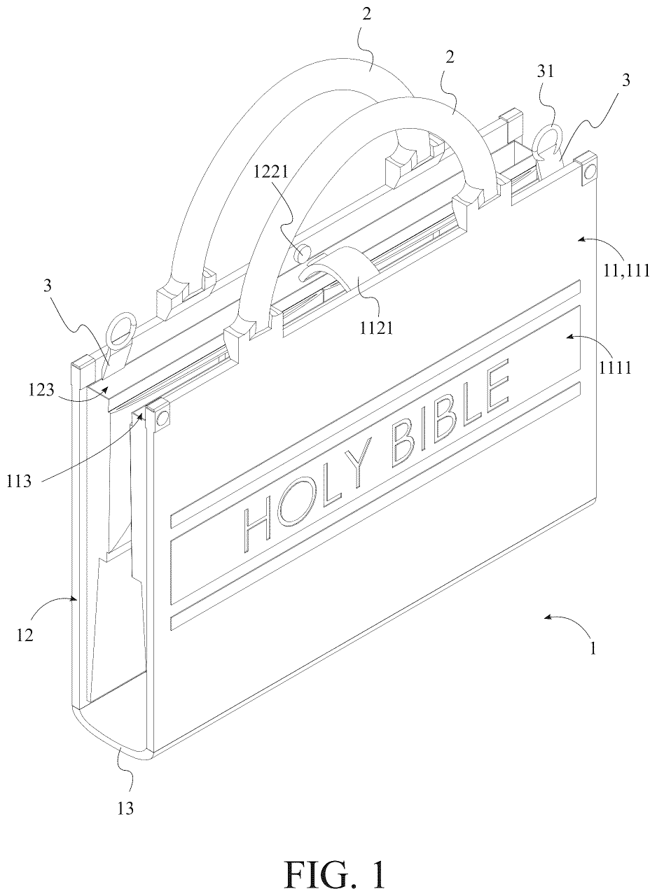

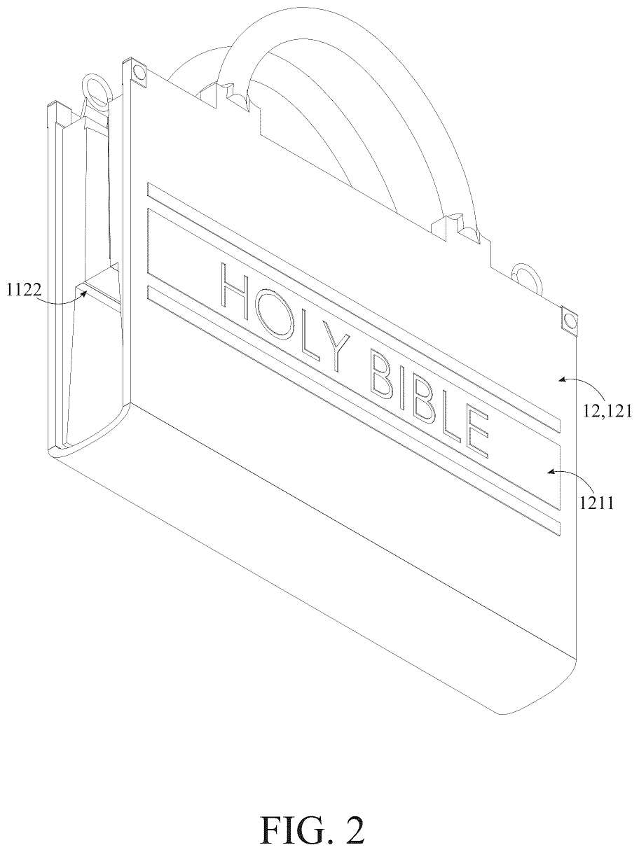

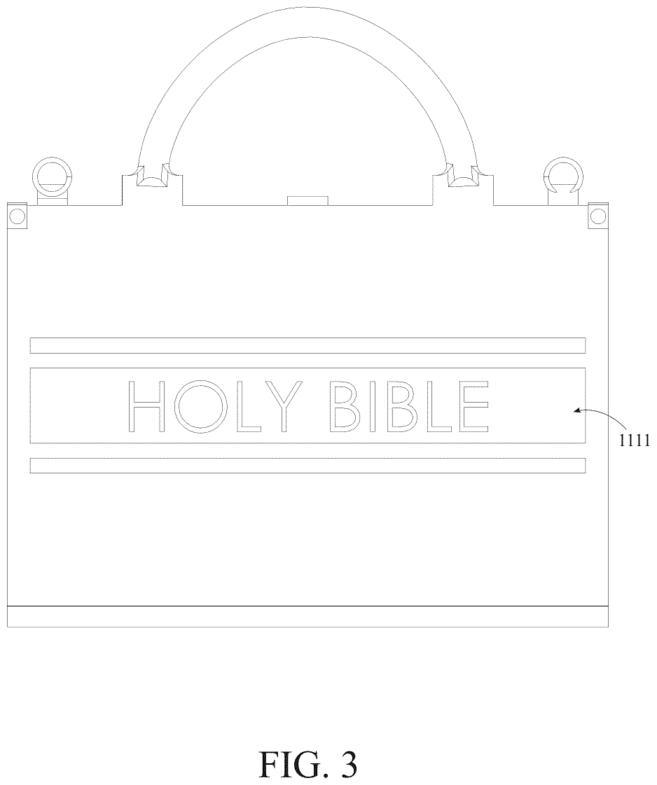

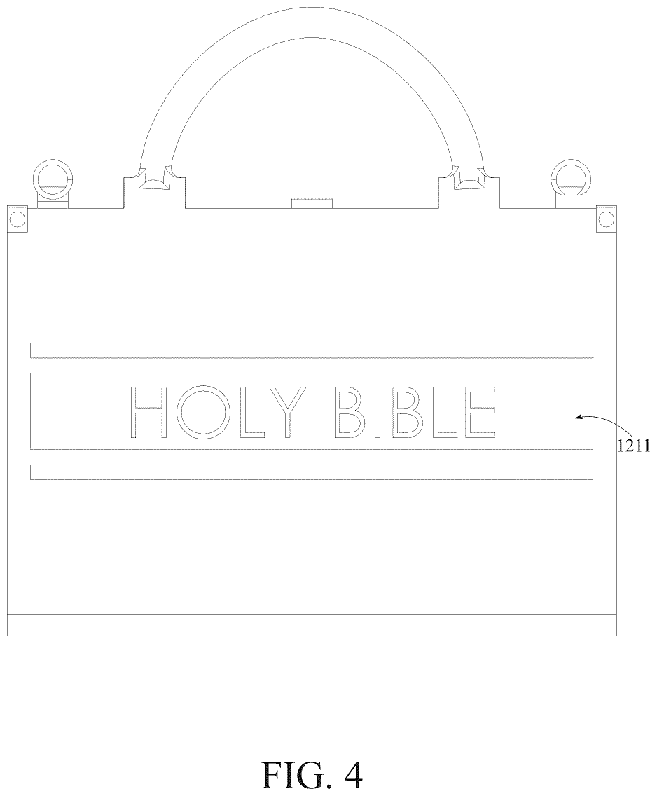

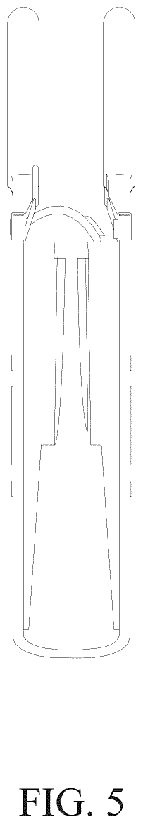

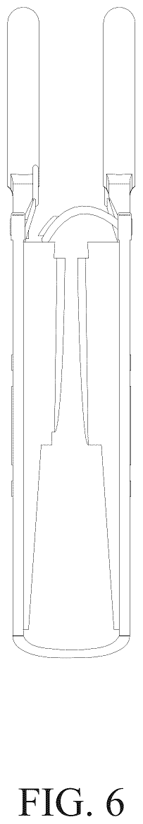

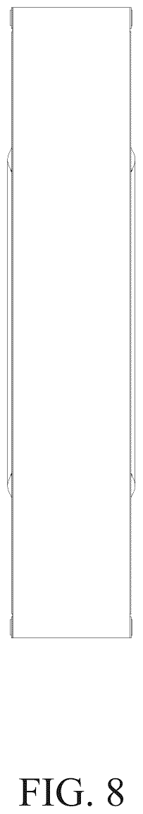

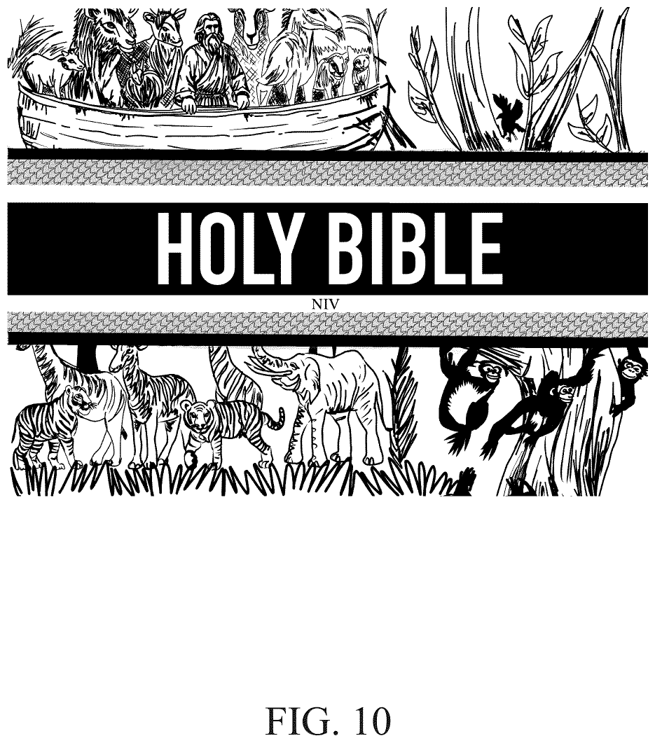

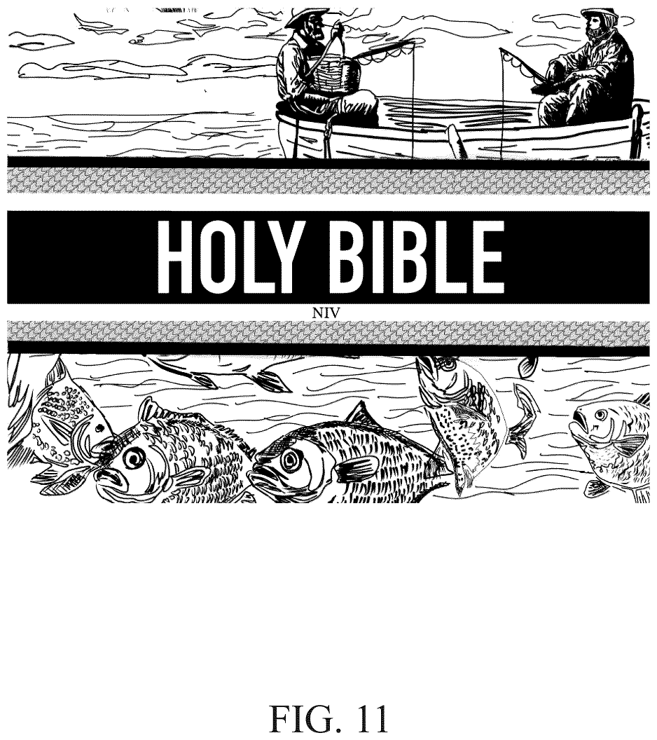

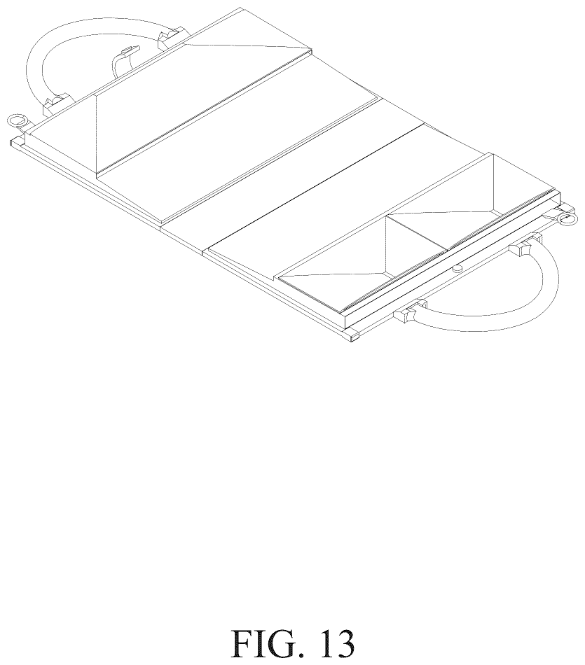

As shown in FIG. 1-13, the present invention is a bible cover that looks like a purse. An objective of the present invention is to provide users with a cover that properly protects a book while providing storage and easy transportation of the book. The present invention intends to provide users with a device that secures a book in place. To accomplish this the present invention comprises a book housing 1 and a plurality of handles 2. Many of these components allow for the user to hold the present invention easily. The plurality of handles 2 is affixed along the top side of the book housing 1 and extends upwards with an arched shape. Thus, the present invention is a bible cover purse that properly encompasses a book and provides a purse design.

The bible cover purse comprises a book housing 1 and a plurality of handles 2. The book housing 1 is preferably designed with a canvas material but could be designed with any type of material. The book housing 1 is configured to encompass and cover a book such as a bible. The book housing 1 comprises a front cover 11, a rear cover 12, and a connecting binding 13. The front cover 11 and the rear cover 12 are rectangular shaped members that cover the front and the rear portions of the book being held by the present invention. The front cover 11 and the rear cover 12 are coupled together via the connecting binding 13. The front cover 11, rear cover 12 and the connecting binding 13 form a singular rectangular shape that is foldable along the connecting binding 13. The connecting binding 13 is flexible, to enabling the book housing 1 to fold. The front cover 11 may be positioned parallel and adjacent to the rear cover 12 in a closed configuration. The closed configuration is when the book housing 1 is folded. The front cover 11 may be positioned in line with and adjacent to the rear cover 12 in an open configuration. The open configuration is when the book housing 1 is unfolded. While in the open configuration or closed configuration the book housing 1 may receive and secure a book in between the front cover 11 and the rear cover 12. The front cover 11 further comprises an inner front cover side 112. The rear cover 12 further comprising an inner rear cover side 122. The inner front cover side 112 and the inner rear cover side 122 are positioned offset one another and facing each other in the closed configuration, shown in FIG. 1. The inner front cover side 112 further comprises a front page pocket 1122. As a result, the front page pocket 1122 may secure the front of the book. The inner rear cover side 122 further comprises a rear page pocket 1222. Consequently, the rear page pocket 1222 may secure the rear of the book. Accordingly, the front page pocket 1122 and rear page pocket 1222 secure the book within the book housing 1 until the book is manually removed by the user.

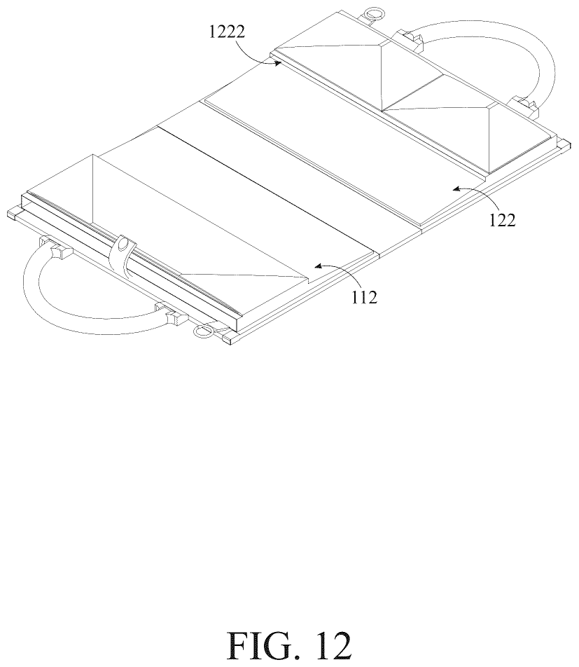

Further, as seen in FIG. 1, each of the plurality of handles 2 attaches to the front cover 11 and the rear cover 12. Thus, the plurality of handles 2 is accessible to the user while the present invention is in an open configuration or a closed configuration. The plurality of handles 2 is secured along the top sides of the front cover 11 and the rear cover 12, extending and curving upwards, forming an arch shape. Each of the plurality of handles 2 is a flexible component that provides the user with a comfortable grip on the present invention. This design enables the present invention to be held similar to a purse, wherein the bible or book is properly secured, and a front design 1111 and a rear design 1211 are displayed along the front cover 11 and rear cover 12 respectively. While in the closed configuration the plurality of handles 2 enables a user to carry the book secured within the book housing 1. So, the book housing 1 wraps around the book, with the plurality of handles 2 extending upwards, wherein the present invention functions as a purse. The front page pocket 1122 is integrated within the inner front cover side 112. The rear page pocket 1222 is integrated within the inner rear cover side 122. As a result, the front page pocket 1122 and the rear page pocket 1222 open inwards while the present invention is in the closed configuration and are not accessible from the outer side of the book housing 1. The book housing 1 and plurality of handles 2 are a fabric material. In an alternative embodiment the book housing 1 and plurality of handles 2 may be made with any flexible and durable material. In an alternative embodiment each of the plurality of handles 2 is made with a vegan leather material and further comprises a handle hole positioned along the ends of each of the plurality of handles 2. Further, the handle hole may receive a key ring wherein the key ring comprises a clasp that enables the key ring to open and close easily, enabling the key ring or plurality of handles 2 to be easily removed or attached from the book housing 1. In this alternative embodiment adjacent holes are positioned along the front cover 11 and rear cover 12 of the book housing 1 to enable the plurality of handles 2 to be attached or detached as needed. This enables the plurality of handles 2 to flex and bend in various directions to accommodate various hand shapes and sizes. In reference to FIG. 12, the front page pocket 1122 opens to receive the front of the book. The rear page pocket 1222 opens to receive the rear of the book. For example, the front page pocket 1122 opens wherein the user slides the front portion of the book and a desired number of pages into the front page pocket 1122. The rear page pocket 1222 then opens wherein the user slides the rear portion of the book into the rear page pocket 1222, holding the book within the book housing 1.

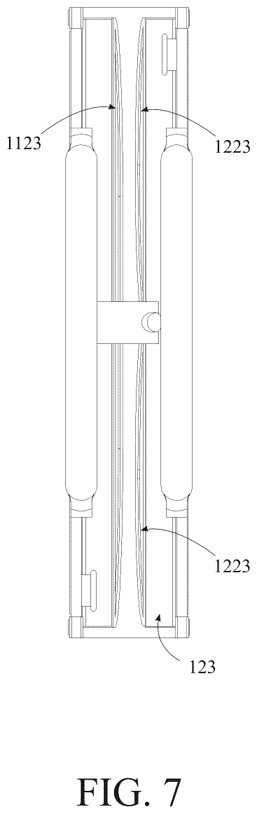

In reference to FIG. 7, the front cover 11 further comprises an outer front cover side 111 and a front cover large pocket 113. The outer front cover side 111 is positioned along the front cover 11 on the opposite side of the inner front cover side 112. The front cover large pocket 113 is a rectangular shaped pocket that traverses the length of the inner front cover side 112. The rear cover 12 further comprises an outer rear cover side 121 and a rear cover large pocket 123. The outer rear cover side 121 is positioned along the rear cover 12 on the opposite side of the inner rear cover side 122. The rear cover large pocket 123 is a rectangular shaped pocket that traverses the length of the inner rear cover side 122.

Furthermore, the front cover large pocket 113 opens to receive items from the user. The rear cover large pocket 123 opens to receive items from the user. The front cover large pocket 113 and the rear cover large pocket 123 both open along one end, the upper end when the present invention is in a closed configuration as seen in FIG. 7. The front cover large pocket 113 and the rear cover large pocket 123 may open and receive items while the front page pocket 1122 and the rear page pocket 1222 secure the book within the book housing 1.

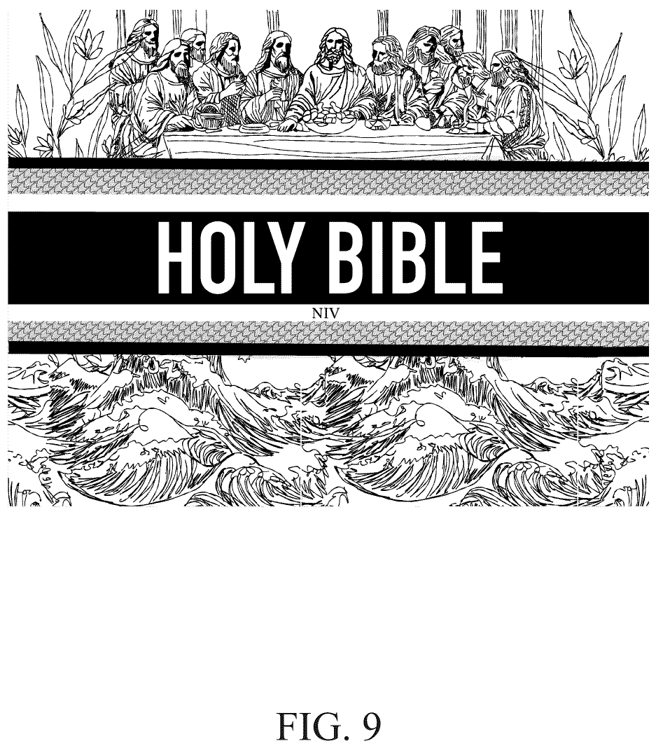

Further, the outer front cover side 111 comprises a front design 1111. The front design 1111 provides a unique design with Jesus and his disciples, waves. The outer rear cover side 121 comprises a rear design 1211 similar to that of the front design 1111. The front design 1111 and/or rear design 1211 displays the words “Holy Bible”. The front design 1111 and rear design 1211 may comprise various artistical scenes and depictions. As seen in FIG. 9-11, various examples of religious artwork is shown along the outer front cover side 111 or outer rear cover side 121.

As shown in FIG. 1, the inner front cover side 112 further comprises a magnetic clasp 1121 and a mesh pouch 1123. The magnetic clasp 1121 is a magnetic member with a circular shape attached along a rectangular strap. The magnetic clasp 1121 may further be designed with a leather material. In an alternative embodiment the magnetic clasp 1121 may have a thin profile or may have a long length wherein the magnetic clasp 1121 wraps around the book housing 1 before coupling to a magnetic receiver 1221. In yet another an alternative embodiment, the magnetic clasp 1121 may have a thick shape configured to provide more protection to the book housing 1. The mesh pouch 1123 is a rectangular shaped pocket that is partially transparent due to the mesh material utilized. Mesh pouch 1123 is integrated within the inner front cover side 112. As a result the mesh pouch 1123 is accessible to the user from the inside of the book housing 1. The mesh pouch 1123 opens to receive items from the user. Consequently, the mesh pouch 1123 holds smaller items such as coins and other similar sized items. The mesh pouch 1123 is positioned adjacent to the front page pocket 1122. Accordingly, the mesh pouch 1123 opens inwards and does not interfere with the functionality of the front page pocket 1122. The inner rear cover side 122 further comprises the magnetic receiver 1221 and plurality of rear small pockets 1223. The magnetic receiver 1221 is a magnetic member with a circular shape and a polarity opposite that of the magnetic clasp 1121. As a result, the magnetic receiver 1221 engages with the magnetic clasp 1121, securing the book housing 1 shut in the closed configuration, until the magnetic receiver 1221 and the magnetic clasp 1121 are disengaged. The plurality of rear small pockets 1223 open to receive items from the user. Each of the plurality of rear small pockets 1223 is a rectangular shaped pocket configured to receive slim items such as a credit card or phone. The plurality of rear small pockets 1223 is integrated within the inner rear cover side 122. Thus, the plurality of rear small pockets 1223 do not interfere with the functionality of the rear page pocket 1222.

Furthermore, the magnetic clasp 1121 is integrated along the inner front cover side 112. So, the magnetic clasp 1121 is positioned away from the opening of the front page pocket 1122 and the front cover large pocket 113. The magnetic clasp 1121 is flexible and may stretch towards the inner rear cover side 122. As a result, the magnetic clasp 1121 may couple the two ends of the front cover 11 and the rear cover 12 opposite the connecting binding 13 together, while in the closed configuration. The magnetic receiver 1221 is integrated along the inner rear cover side 122. The magnetic receiver 1221 is positioned across from the magnetic clasp 1121 while the present invention is in the closed configuration. The magnetic clasp 1121 magnetically couples to the magnetic receiver 1221 while in the closed configuration.

The bible cover purse further comprises a plurality of straps 3 as shown in FIG. 1. Each of the plurality of straps 3 has a rectangular shape that is affixed and extends from the front cover 11 or rear cover 12. Each of the plurality of straps 3 further comprising a ring 31. The ring 31 is a circular or loop shaped member. The ring 31 is affixed along the end of each of the plurality of straps 3. Thus, the ring 31 is secured to each of the plurality of straps 3 and may rotate in place. Each of the plurality of straps 3 is integrated along a corner of the front cover 11 and the rear cover 12. Preferably, each of the plurality of straps 3 is positioned opposite each other. The plurality of straps 3 enables a long strap or chain to be attached to the book housing 1, which enables the book housing 1 to be slung over and carried on the shoulder of the user. With all the components working in tandem with each other it can be seen that, the present invention is a bible cover purse that properly encompasses a book and while functioning as a purse.

Although the invention has been explained in relation to its preferred embodiment, it is to be understood that many other possible modifications and variations can be made without departing from the spirit and scope of the invention as hereinafter claimed.

What is claimed is:

1. A bible cover purse comprising:
a book housing;
a plurality of handles;
the book housing comprising a front cover, a rear cover, and a connecting binding;
the front cover further comprising an inner front cover side;
the inner front cover side further comprising a front page pocket;
the rear cover further comprising an inner rear cover side;
the inner rear cover side further comprising a rear page pocket;
the front cover and the rear cover are coupled together via the connecting binding;
the connecting binding is flexible;
the front cover may be positioned parallel and adjacent to the rear cover in a closed configuration;
the front cover may be positioned in line with and adjacent to the rear cover in an open configuration;
the book housing may receive and secure a book in between the front cover and the rear cover;
the front page pocket may secure the front of the book; and
the rear page pocket may secure the rear of the book.

2. The bible cover purse as claimed in claim 1 comprising:
each of the plurality of handles attaches to the front cover and the rear cover;
the plurality of handles enables a user to carry the book secured within the book housing;
the front page pocket is integrated within the inner front cover side;
the rear page pocket is integrated within the inner rear cover side; and
the book housing and plurality of handles are a fabric material.

3. The bible cover purse as claimed in claim 2 comprising:
the front page pocket opens to receive the front of the book; and
the rear page pocket opens to receive the rear of the book.

4. The bible cover purse as claimed in claim 2 comprising:
the front cover further comprises an outer front cover side and a front cover large pocket; and
the rear cover further comprises an outer rear cover side and a rear cover large pocket.

5. The bible cover purse as claimed in claim 4 comprising:
the front cover large pocket opens to receive items from the user;
the rear cover large pocket opens to receive items from the user; and
the front cover large pocket and the rear cover large pocket may open and receive items while the front page pocket and the rear page pocket secure the book within the book housing.

6. The bible cover purse as claimed in claim 4 comprising:
the outer front cover side comprises a front design;
the outer rear cover side comprises a rear design;
the front design and rear design displays the words “Holy Bible”; and
the front design and rear design may comprise various artistical scenes and depictions.

7. The bible cover purse as claimed in claim 1 comprising:
the inner front cover side further comprises a magnetic clasp and a mesh pouch;
the inner rear cover side further comprises a magnetic receiver and plurality of rear small pockets;
mesh pouch is integrated within the inner front cover side;
the mesh pouch opens to receive items from the user;
the mesh pouch is positioned adjacent to the front page pocket;
the plurality of rear small pockets open to receive items from the user; and
the plurality of rear small pockets is integrated within the inner rear cover side.

8. The bible cover purse as claimed in claim 7 comprising:
the magnetic clasp is integrated along the inner front cover side;
the magnetic clasp is flexible and may stretch towards the inner rear cover side;
the magnetic receiver is integrated along the inner rear cover side; and
the magnetic clasp magnetically couples to the magnetic receiver while in the closed configuration.

9. The bible cover purse as claimed in claim 1 further comprising:
a plurality of straps;
each of the plurality of straps further comprising a ring;
the ring is affixed along the end of each of the plurality of straps;
each of the plurality of straps is integrated along a corner of the front cover and the rear cover; and
the plurality of straps enables a long strap or chain to be attached to the book housing, which enables the book housing to be slung over and carried on the shoulder of the user.

10. A bible cover purse comprising:
a book housing;
a plurality of handles;
the book housing comprising a front cover, a rear cover, and a connecting binding;
the front cover further comprising an inner front cover side;
the inner front cover side further comprising a front page pocket;
the rear cover further comprising an inner rear cover side;
the inner rear cover side further comprising a rear page pocket;
the front cover and the rear cover are coupled together via the connecting binding;
the connecting binding is flexible;
the front cover may be positioned parallel and adjacent to the rear cover in a closed configuration;
the front cover may be positioned in line with and adjacent to the rear cover in an open configuration;
the book housing may receive and secure a book in between the front cover and the rear cover;
the front page pocket may secure the front of the book;
the rear page pocket may secure the rear of the book;
each of the plurality of handles attaches to the front cover and the rear cover;
the plurality of handles enables a user to carry the book secured within the book housing;
the front page pocket is integrated within the inner front cover side;
the rear page pocket is integrated within the inner rear cover side;
the book housing and plurality of handles are a fabric material;
the front page pocket opens to receive the front of the book; and
the front cover further comprises an outer front cover side and a front cover large pocket.

11. The bible cover purse as claimed in claim 10 comprising the rear page pocket opens to receive the rear of the book.

12. The bible cover purse as claimed in claim 10 comprising the rear cover further comprises an outer rear cover side and a rear cover large pocket.

13. The bible cover purse as claimed in claim 12 comprising:
the front cover large pocket opens to receive items from the user;
the rear cover large pocket opens to receive items from the user; and
the front cover large pocket and the rear cover large pocket may open and receive items while the front page pocket and the rear page pocket secure the book within the book housing.

14. The bible cover purse as claimed in claim 12 comprising:
the outer front cover side comprises a front design;
the outer rear cover side comprises a rear design;
the front design and rear design displays the words “Holy Bible”; and
the front design and rear design may comprise various artistical scenes and depictions.

15. The bible cover purse as claimed in claim 10 comprising:
the inner front cover side further comprises a magnetic clasp and a mesh pouch;
the inner rear cover side further comprises a magnetic receiver and plurality of rear small pockets;
mesh pouch is integrated within the inner front cover side;
the mesh pouch opens to receive items from the user;
the mesh pouch is positioned adjacent to the front page pocket;
the plurality of rear small pockets open to receive items from the user;
the plurality of rear small pockets is integrated within the inner rear cover side;
the magnetic clasp is integrated along the inner front cover side;
the magnetic clasp is flexible and may stretch towards the inner rear cover side;
the magnetic receiver is integrated along the inner rear cover side; and
the magnetic clasp magnetically couples to the magnetic receiver while in the closed configuration.

16. The bible cover purse as claimed in claim 10 further comprising:
a plurality of straps;
each of the plurality of straps further comprising a ring;
the ring is affixed along the end of each of the plurality of straps;
each of the plurality of straps is integrated along a corner of the front cover and the rear cover; and
the plurality of straps enables a long strap or chain to be attached to the book housing, which enables the book housing to be slung over and carried on the shoulder of the user.

17. A bible cover purse comprising:
a book housing;
a plurality of handles;
the book housing comprising a front cover, a rear cover, and a connecting binding;
the front cover further comprising an inner front cover side;
the inner front cover side further comprising a front page pocket;
the rear cover further comprising an inner rear cover side;
the inner rear cover side further comprising a rear page pocket;
the front cover and the rear cover are coupled together via the connecting binding;
the connecting binding is flexible;
the front cover may be positioned parallel and adjacent to the rear cover in a closed configuration;
the front cover may be positioned in line with and adjacent to the rear cover in an open configuration;
the book housing may receive and secure a book in between the front cover and the rear cover;
the front page pocket may secure the front of the book;
the rear page pocket may secure the rear of the book;
each of the plurality of handles attaches to the front cover and the rear cover;
the plurality of handles enables a user to carry the book secured within the book housing;
the front page pocket is integrated within the inner front cover side;
the rear page pocket is integrated within the inner rear cover side;
the book housing and plurality of handles are a fabric material;
the front page pocket opens to receive the front of the book;
the front cover further comprises an outer front cover side and a front cover large pocket;
the rear page pocket opens to receive the rear of the book;
the rear cover further comprises an outer rear cover side and a rear cover large pocket;
the front cover large pocket opens to receive items from the user;
the outer front cover side comprises a front design; and
the outer rear cover side comprises a rear design.

18. The bible cover purse as claimed in claim 17 comprising:
the rear cover large pocket opens to receive items from the user;
the front cover large pocket and the rear cover large pocket may open and receive items while the front page pocket and the rear page pocket secure the book within the book housing;
the front design and rear design displays the words “Holy Bible”; and
the front design and rear design may comprise various artistical scenes and depictions.

19. The bible cover purse as claimed in claim 17 comprising:
the inner front cover side further comprises a magnetic clasp and a mesh pouch;
the inner rear cover side further comprises a magnetic receiver and plurality of rear small pockets;
mesh pouch is integrated within the inner front cover side;
the mesh pouch opens to receive items from the user;
the mesh pouch is positioned adjacent to the front page pocket;
the plurality of rear small pockets open to receive items from the user;
the plurality of rear small pockets is integrated within the inner rear cover side;
the magnetic clasp is integrated along the inner front cover side;
the magnetic clasp is flexible and may stretch towards the inner rear cover side;
the magnetic receiver is integrated along the inner rear cover side; and
the magnetic clasp magnetically couples to the magnetic receiver while in the closed configuration.

20. The bible cover purse as claimed in claim 17 further comprising:
a plurality of straps;
each of the plurality of straps further comprising a ring;
the ring is affixed along the end of each of the plurality of straps;
each of the plurality of straps is integrated along a corner of the front cover and the rear cover; and
the plurality of straps enables a long strap or chain to be attached to the book housing, which enables the book housing to be slung over and carried on the shoulder of the user.
